(19) United States
(12) Patent Application Publication
(10) Pub. No.: US 2008/0080306 A1
(43) Pub. Date: Apr. 3, 2008

(54) MICROCAPILLARY REACTOR AND METHOD FOR CONTROLLED MIXING OF NONHOMOGENEOUSLY MISCIBLE FLUIDS USING SAID MICROCAPILLARY REACTOR

(75) Inventors: Yucel Onal, Erlenbach (DE); Martin Lucas, Darmstadt (DE); Peter Claus, Berlin (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TECHNISCHE UNIVERSITAT DARMSTADT, Darmstadt (DE)

(21) Appl. No.: 11/697,246

(22) Filed: Apr. 5, 2007

Related U.S. Application Data
(63) Continuation of application No. PCT/DE2005/001783, filed on Oct. 6, 2005.

(30) Foreign Application Priority Data
Oct. 11, 2004 (DE) 102004049730.3

(51) Int. Cl. B01F 3/04; B01F 5/00; B01J 19/24

(52) U.S. Cl. 366/348; 422/224

(57) ABSTRACT

A microcapillary reactor contains at least one first static mixer comprising at least one first capillary supply line for a first fluid and at least one second capillary supply line for a second fluid which is not substantially homogeneously miscible with the first fluid. The first and second capillary supply lines flow into a region which is the point of departure for at least one transport line. The first and second capillary supply lines are dimensioned such that the first and second fluids can be respectively transported in laminary flow conditions and can be displaced in the form of alternatingly successive discrete liquid phase sections (plugs). The microcapillary reactor further comprises at least one second static mixer, comprising at least one third supply line, particularly a capillary supply line, for a gaseous third fluid which flows in the first capillary transport line downstream from the first mixer.

### BACKGROUND

Recent years have seen the emergence of microreactor technology. Microcapillary reactors are known from WO 01/64332 A1, for example. This microcapillary reactor basically represents a T-mixer having two supply lines and one discharge line. Two substantially immiscible liquids are fed through the two supply lines, preferably meeting head-on, with the result that the intermixed liquids are transmitted in the common discharge line of the microcapillary reactor in the form of successively alternating, miniaturized fluid blocks (plugs). A high degree of common phase boundary is provided between the immiscible fluid components, at which diffusion-controlled reactions, for example, can take place. However, it is important that the diameters of the discharge and supply lines be selected to be as small as possible, and in particular so as not to exceed 1000 μm. According to WO 01/64332 A1, the disclosed microcapillary reactor may be used to carry out liquid/gaseous, solid/liquid/liquid, and solid/liquid/gaseous reactions. The solid phase may be provided, for example, as a coating on the inner wall of the discharge line. Nitration of benzene and toluene, for example, may be performed by use of the microcapillary reactor according to WO 01/64332 A1.

In addition to the above-described variant for intimate mixing of immiscible liquids by means of two capillary streams meeting head-on in a T-mixer, the main features of which have been described in U.S. Pat. No. 5,921,678, it is possible to achieve highly efficient contact between two immiscible liquids by means of parallel liquid streams, as disclosed in WO 97/39814 and WO 99/22858. Mass transport between the immiscible fluids flowing essentially in parallel occurs by diffusion at the phase boundary, perpendicular to the direction of flow.

The use of Y-shaped microcapillary reactors for the nitration of benzene or toluene in liquid/liquid systems is described, among other sources, by G. Dummann et al., Catalysis Today 79-80 (2003)433-439.

According to EP 1 329 258 A2, for carrying out continuous processes microcapillary reactors may also be used in the form of plates or stacked plates provided on their surfaces with miniaturized functional spaces or channels in which the liquid phase flows in at least one continuous capillary thread due to gravity and/or capillary forces. This device may be used to carry out chemical reactions and physical processes, whereby liquid or gaseous components and reaction products that are generated may be removed from the liquid phase in a controlled, continuous manner.

Improvements in microreactors, in particular microcapillary reactors, is desirable to further expand and better utilize their potential applications. For example, although microreactor technology is still emerging, it is recognized that it is suitable not only for analytical purposes, but also for commercial synthesis processes. See O. Wörz, et al., Chemical Engineering Science 56 (2001)1029-1033. Therefore, it is advantageous to have a microreactor with very large surface-to-volume ratios, so that even very rapid and very exothermic reactions may be carried out under essentially isothermal conditions. The present invention seeks to fulfill these needs and provides further related advantage.

### SUMMARY

This summary is provided to introduce a selection of concepts in a simplified form that are further described below in the Detailed Description. This summary is not intended to identify specific key features of the claimed subject matter.

In one aspect, the present invention relates to a microcapillary reactor containing at least one first static mixer, comprising at least one first capillary supply line for a first liquid fluid, at least one second capillary supply line for a second liquid fluid which is not substantially homogeneously miscible with the first fluid, the first and second capillary supply lines flowing into a region which is the starting point for at least one first transport line, and the first and second capillary supply lines being dimensioned such that at least the first and second fluids may each be transported under laminar flow conditions and may be transmitted in the form of successively alternating, discrete liquid phase sections (plugs).

In another aspect, the present invention relates to a method for controlled mixing of at least two fluids which are not substantially homogeneously miscible and at least one is a gaseous fluid.

In another aspect, the invention relates to the use of the microcapillary reactor. For example, the microcapillary reactor of the invention can be used for hydrogenation, hydroformylation, carbonylation, and oxidation of organic compounds.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a schematic diagram of a microcapillary reactor according to the invention;

FIG. 2 shows an alternative schematic diagram of a microcapillary reactor according to the invention;

FIG. 3 shows a schematic longitudinal section of the transport line of the microcapillary reactor according to the invention; and

FIG. 4 shows a flow diagram of a microcapillary reactor system according to the invention.

### DETAILED DESCRIPTION

Described herein is a microcapillary reactor which does not have the disadvantages of the prior art, allows broader application from an analytical and synthetic standpoint, and also permits the controlled mixing and reaction of liquid/liquid/gaseous systems in a very effective manner.

In one embodiment, a microcapillary reactor contains at least one first static mixer, comprising at least one first capillary supply line for a first liquid fluid, and at least one second capillary supply line for a second liquid fluid which is not substantially homogeneously miscible with the first fluid. The first and second capillary supply lines flowing into a region which is the starting point for at least one first transport line. The first and second capillary supply lines are dimensioned such that at least the first and second fluids may each be transported under laminar flow conditions and may be transmitted in the form of successively alternating, discrete liquid phase sections (plugs).

Further disclosed is a microcapillary reactor which is characterized by at least one second static mixer containing at least one third supply line, in particular a capillary supply line, for a gaseous third fluid which flows into the first capillary transport line downstream from the first mixer. Extension lines may also be provided for the first, second, and/or third supply line, and/or from or in the first transport line.

The first and/or second mixer may constitute uniform material blocks. The uniform material blocks can be made from a plastic material or metal. The first, second, and/or third supply lines as well as the first transport lines can be incorporated by means of boreholes in the uniform material blocks. These static mixers may also be composed of molded plastic or cast metal components.

The first and second static mixers can be present in a uniform material block or to be immediately adjacent or connected to one another. The first and second mixers may also be spatially separated, and the first transport line, optionally connected to an extension line, may connect both mixers.

For feeding the fluids to these static mixers, corresponding first, second, and third extension lines may be used which make a sealed connection to the first, second, or third supply line. The extension lines advantageously have essentially the same inner diameter as the supply lines to which they are connected. Furthermore, the first transport line may likewise be connected to a fourth extension line after exiting the second mixer. In addition, a fifth extension line may be connected between the first transport line leading from the first mixer and the first transport line leading into the second mixer. In turn, it is advantageous for the inner diameter of these fourth and fifth extension lines to be essentially the same as the inner diameter of the first transport line.

The first mixer for the microcapillary reactor, in at least one embodiment, is based on the functional principle of the static mixer described in WO 01/64332 A1. The immiscible liquids are accordingly delivered to the first and second capillary supply lines in the manner of a common transport line, resulting in alternating fluid blocks which are not homogeneously miscible, while maintaining or forming a cohesive fluid stream. The term “alternating plug flow system” is also used in this regard.

By use of the second mixer it is possible to selectively feed the gaseous third fluid only into the plugs of the first or the second fluid. Each of these fluid blocks may contain a gas bubble. This gas bubble preferably oscillates within a fluid block between the phase boundaries of adjoining, immiscible fluid blocks.

In one preferred embodiment, at least the inner wall of the first transport line and/or at least the inner wall of the first, second, and/or third supply line and/or the extension lines for the first, second, and/or third supply line and/or for the first transport line is/are provided, at least in places, with a polarity which has a greater affinity for the first or the second fluid. Surprisingly, it has been shown that when the polarity of at least the inner wall of the first transport line is adapted to that of one of the immiscible fluids used, the gaseous third fluid is introduced in a particularly controlled and selective manner into the fluid blocks/plugs which have the identical or similar polarity as the inner wall of the transport line. Control is thus provided in the selection of the material of the first transport line into which fluid blocks or segments of the gaseous fluid are to be supplied. Surprisingly, it has also been shown that the result of supplying the gas phase into fluid blocks of uniform polarity in a controlled, selective manner is also achieved when at least the inner wall of the section of the first transport line connected to the second mixer, and/or the fourth extension line, based on or composed of a plastic such as Teflon, for example, is/are provided, at least in places, with a polarity which has a greater affinity for the first or the second fluid.

In the microcapillary reactors according to the invention, the inner wall of the first transport line, for example in the section adjoining the second mixer, may be provided in the partially or completely nonpolar state, at least in places. As used herein, “nonpolar” or “nonpolar surface” is understood to mean a surface, using water as test liquid, which has a contact angle of ≧90° determined according to the Sessil drop method, for example. Preferred nonpolar surfaces have a contact angle >90°. For example, at least one first transport line, particularly the inner wall thereof, may be composed, at least in places, of a preferably nonpolar plastic, such as Teflon.

In principle, any polymeric materials may be used which are nonreactive with the fluid components, and/or which cannot be dissolved or solubilized by same. In addition to polytetrafluoroethylene (PTFE; Teflon), polyolefinic materials such as polyethylene or polypropylene; polyamides; polyoxyalkylenes such as POM; polystyrenes; styrene copolymers such as ABS, ASA, or SAN; and polyphenylene ethers or polyesters such as PET or PBT may be considered. When a nonpolar polymeric material such as Teflon is used, hydrogen may be readily supplied as the third fluid into the organic nonpolar fluid plug via the second static mixer for the microcapillary reactor.

One advantage, among others, of a microcapillary reactor as described herein is that, preferably when the polarity of the inner wall of the first transport line is matched to the polarity of the first or second fluid, the gaseous fluid, even with continuous feed, enters only into the fluid plugs of the first or second fluid in a controlled and reproducible manner. If the gaseous third fluid is, for example, a reaction gas such as hydrogen, oxygen, or carbon monoxide, or a hydrogen/carbon monoxide mixture, this fluid may be selectively introduced into nonpolar organic solvent plugs in which the starting product components may be present in dissolved form. In general, a reaction takes place along the phase boundaries of the liquid/liquid system, for example, when a homogeneously dissolved hydrogenation catalyst is present in the aqueous phase.

The first transport line, in particular the inner wall thereof, may also be composed of metal and/or glass, at least in places.

In one alternative embodiment according to the invention, the first transport line may be thermostatically controlled upstream from and in particular downstream from the opening of the third supply line. As used herein, a first transport line is a line in which not just one fluid component, but, rather, at least a two-phase mixture and, after introduction of the third fluid component, a three-phase mixture are transported. After the third fluid component is added to the second static mixer, the chemical reaction takes place in this first transport line or in an extension line of this transport line, at the phase boundaries of the liquid fluid segments. The duration of the reaction may be controlled as a function of the flow rate, in particular by the length of the first transport line or an extension line adjoining this first transport line downstream from the opening of the third supply line into the second mixer.

Thus, for example, the length of the section of the first transport line, with or without an extension line, which starts downstream from the opening of the third supply line into the second mixer may range from 0.1 to 50 m.

To produce and maintain alternating fluid segments, it is advantageous for the first, second, and/or third supply line and/or the first transport line and/or at least one extension line to have a diameter, at least in places, not exceeding 1000 μm, in particular ranging from 50 to 1000 μm. For example, suitable cross-sectional areas can be in the range of 400, 500, or 750 μm.

The flow in capillaries having small channel diameters of <1000 μm generally differs from normal flow profiles in conventional tubular reactors. The flow in these capillaries is usually present as laminar flow. In principle, such lines are suitable for which a laminar flow can be maintained, preferably over their entire length. Suitable flow rates for these laminar flows in the lines of the reactor range from approximately 6 to 15,000 μL/min.

Production of alternating fluid segments may be facilitated by the fact that the first and second supply lines for the first mixer have opening regions which are essentially oppositely oriented. The first and second fluids which meet head-on are transmitted in a segmented manner, as previously described, in a first transport line which extends perpendicular to the first and second supply lines.

Alternatively, the first and second supply lines may meet with their opening sections oriented at essentially right angles.

The first and second supply lines may also meet with their opening sections oriented at an angle between 90° and 180°, or an angle between 0° and 90°. For example, the first and second supply lines and the transport line may have a Y-shaped design.

The above-described systems of supply lines and discharge lines may also be implemented in the second static mixer. For example, in one preferred embodiment the third supply line and the first transport line present in the second mixer meet oppositely at an angle of approximately 180°. In addition, at its opening region, the third supply line for the second mixer may flow into the first transport line essentially perpendicularly or at angle between 0° and 90° or an angle between 90° and 180°. As a rule, it has proven to be sufficient for the lines of the second mixer to have a T- or Y-piece design. It is particularly preferred for the opening section of the third supply line to essentially form a right angle with the section of the first transport line which supplies the alternating two-phase mixture. The first transport line advantageously changes direction, in particular by approximately 90°, in the contact region with the opening section of the third supply line, so that the section of the first transport line downstream from the contact region forms an angle of approximately 180° with at least the opening region of the third line.

In one embodiment, the first and/or second mixers are T-mixers. In another embodiment, the first and/or second mixers are Y-mixers.

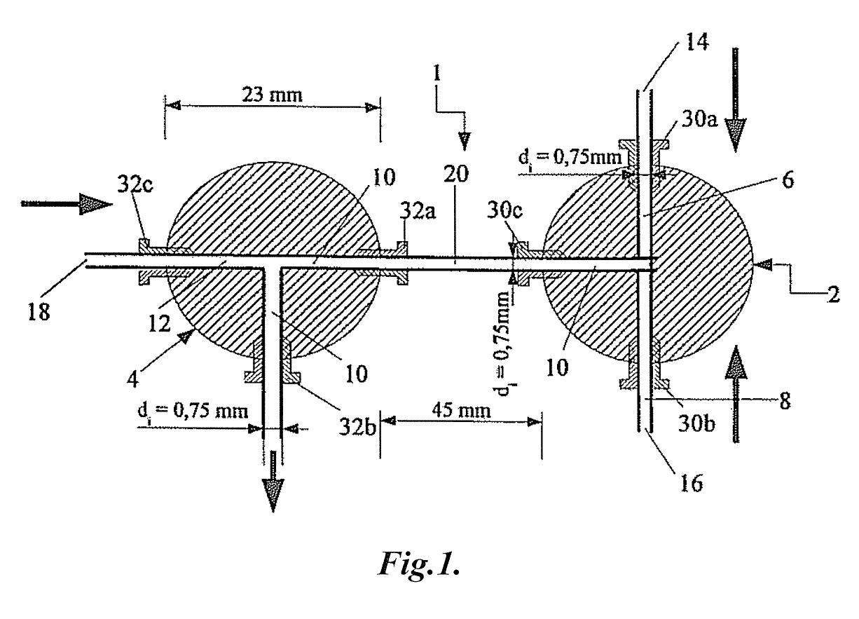

FIG. 1 shows a microcapillary reactor 1 according to an embodiment of the invention, comprising a first mixer 2 and a second mixer 4 which are configured in series. The first mixer 2 includes a first supply line 6 and a second supply line 8 which converge at an angle of 180°, and both supply lines flow or merge into the first transport line 10. In the illustrated embodiment, the inner diameter of each of lines 6, 8, and 10 is approximately 0.75 mm. The first transport line 10 is also a component of the second mixer 4, and essentially represents the first supply line for this second mixer. In the second mixer 4, a gaseous component is introduced into the transport line 10 via the third supply line 12. In the embodiment illustrated, the angle between the third supply line and the first transport line 10 present in the second mixer 4 is 180°, so that the gaseous component meets the liquid/liquid volumetric flow head-on. The first transport line 10 is then further led into the second mixer 4 at a right angle. In one embodiment, the first, second, and third supply lines may be connected to the first, second, and third extension lines 14, 16, and 18, respectively. In such a design, the first, second, and third supply lines, for example, are essentially present in the first and second mixers, and are connected to the extension lines via suitable connectors 30 a, 30 b, and 32 c. Of course, a fourth extension line 20 may be added in the section of the first transport line 10 located between the first and second mixers 2 and 4, via connectors 30 c and 32 a, respectively. The section adjoining the second mixer may also be considered as an extension line 20 for the first transport line 10.

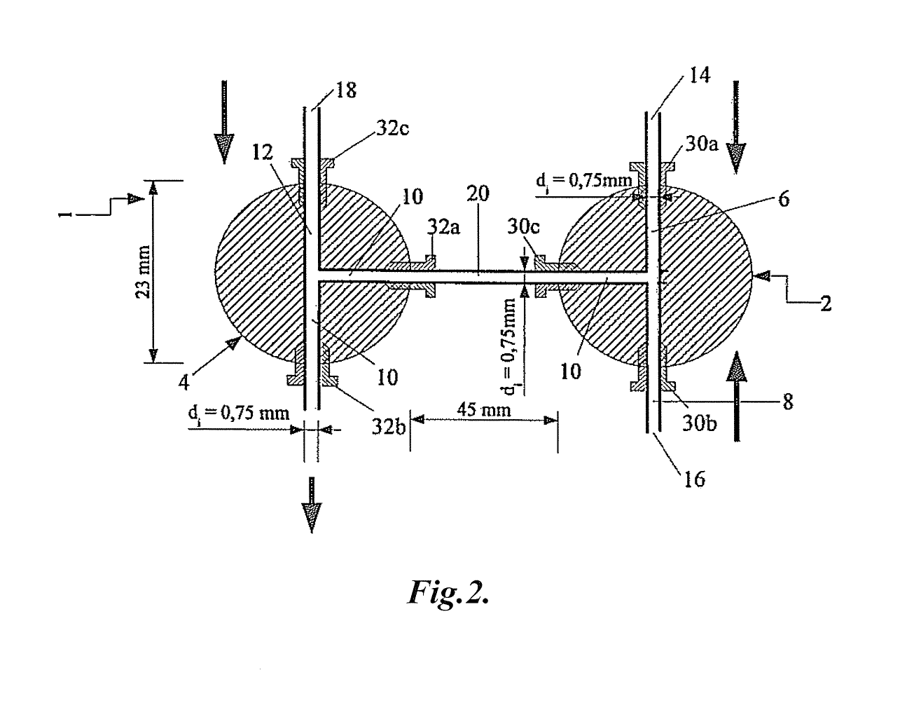

FIG. 2 shows an alternative schematic diagram of a microcapillary reactor 1 according to the invention. The two T-shaped first and second mixers 2 and 4 are provided in essentially a mirror-image configuration. The configuration and the flow paths of the first mixer are identical to the first mixer according to FIG. 1. In addition, in the second mixer 4 the configuration of the first transport line 10 corresponds to that of the second mixer 4 according to FIG. 1. However, in the second mixer 4 the opening section of the third supply line 18 for the gaseous third fluid is perpendicular to the first transport line 10 leading into the second mixer 4. This type of feed of the gaseous fluid component is preferred in many cases.

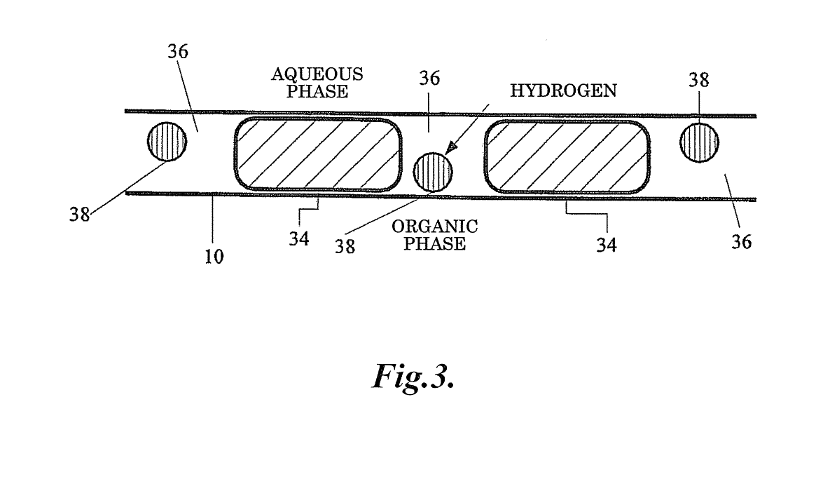

FIG. 3 shows a longitudinal section of a segment of the first transport line 10 after the gaseous component has been introduced into the second mixer 4 via the third supply line 12. FIG. 3 shows that fluid blocks or plugs 34 and 36 of an aqueous or organic phase are alternatingly present in the first transport line 10. For an inner capillary diameter of 0.75 mm, the individual plugs have a length of approximately 1.3 mm, depending on the flow rate. The generation of such a flow pattern is described in WO 01/64332 A1. Although in the second mixer 4, hydrogen is continuously introduced into the two-phase volumetric flow in the first transport line 10, in the device the gaseous phase 38 is situated or incorporated, for example, in an organic phase block having a small bubble size, located between two successive aqueous phase blocks. This is achieved in particular by the fact that at least the inner wall of the section of the first transport line 10 extending in the second mixer 4 has a greater affinity for the organic phase than for the aqueous phase. A desired chemical reaction may then readily proceed at the phase boundaries in the three-phase mixture present in the first transport line 10 after admixture of the gaseous phase.

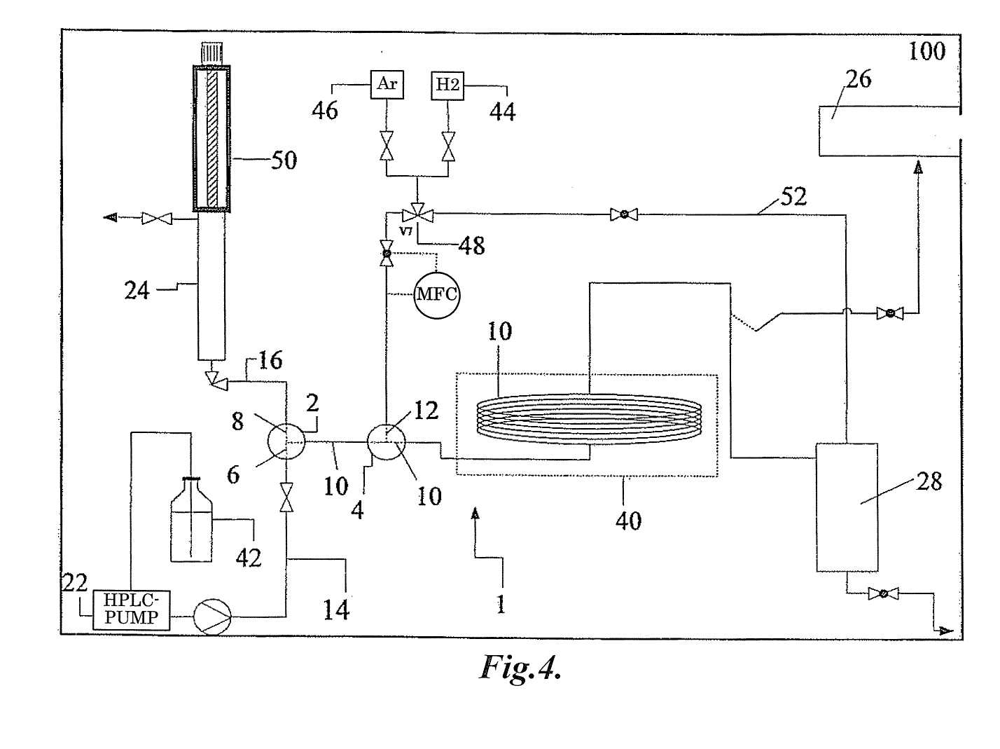

FIG. 4 shows a schematic illustration of the structure of a microcapillary reactor system 100. The key element of this system is the microcapillary reactor 1, comprising a first mixer 2 and a second mixer 4 which are connected to one another via the first transport line 10. The liquid organic phase, which contains the starting material in dissolved form, is introduced via the first extension line 14 into the first supply line 6 for the first mixer 2, from a supply container 42 by use of an HPLC pump 22. The aqueous phase, containing, for example, a homogeneously dissolved catalyst, is similarly fed into the second supply line 8 for the first mixer 2 via an extension line 16 from a supply container 24 by use of a reciprocating pump or syringe pump. As previously described for FIG. 1, controlled mixing of the immiscible organic and aqueous phases is carried out in the mixer 2, forming an alternating plug flow system. The gaseous component is fed into the second mixer 4 via a third supply line 12. This may be, for example, pure hydrogen from a hydrogen supply container 44 or an H₂/Ar mixture. Argon is admixed via a separate supply container 46 by means of a mixing station 48. In general, argon is used for removing oxygen from the first and second fluids; repeated gassing with argon is performed before the pressurization with hydrogen. The first transport line 10 is led out from the second mixer 4, and may then extend over a longer section which, as illustrated, may be held at constant temperature by means of a heater 40. The multiphase mixture is preferably randomly fed to a sample analyzer 26 in the form of a gas chromatograph, for example, via a branch from the first transport line 10. The first transport line flows into the product collection container 28. The reaction mixture obtained may then be processed and the desired reaction product isolated. Via the line 52 a pressure is established in the product collection container which essentially corresponds to the pressure in the transport line.

Another feature of the invention is to provide a method for controlled mixing of liquid/liquid/gaseous systems, by means of which multiphase reactions such as catalytically controlled multiphase reactions may be effectively carried out.

In one aspect, this feature may be achieved by a method for controlled mixing of at least two liquid fluids, which are not substantially homogeneously miscible, with at least one gaseous fluid.

In one embodiment, a first liquid fluid via at least one first supply line for a first static mixer and a second liquid fluid via at least one second supply line for the first static mixer are combined in a region which is the starting point for at least one first transport line. The first and second capillary supply lines and the transport line may be dimensioned such that the first and second fluids may each be transported under laminar flow conditions and may be transmitted in the first transport line in the form of successively alternating, discrete liquid phase sections (plugs). The gaseous third fluid may be fed via a third supply line, in particular a capillary supply line, for a second static mixer into the first transport line downstream from the first mixer.

Methods according to the invention may be used for varieties of chemical reactions. For example, a method is particularly suited for the catalytic hydrogenation of reducible organic compounds, the catalytic oxidation of organic compounds, for hydroformylation reactions, and for carbonylation reactions in liquid/liquid/gas multiphase systems. Water-soluble catalysts are preferably used for this purpose.

Olefins such as mono- or diolefins and α,β-unsaturated aldehydes, for example, may be considered as starting materials for the hydrogenation reactions according to the invention. Suitable water-soluble catalyst complexes for these hydrogenation processes are known to one skilled in the art. The referenced reactions may be carried out, for example, at hydrogen pressures in the range of 1 to 200 bar. Aldehydes may be obtained from the hydroformylation of olefins, for example, 1-alkenes such as 1-octene. Suitable catalysts are likewise known to one skilled in the art. A catalyst system based on a rhodium complex chelated with biphephos ligands is mentioned by way of example. Such a catalyst may be obtained, for example, from [Rh(acac)(CO)₂] and biphephos ligands in propylene carbonate as solvent.

The hydrogen/carbon monoxide mixture used for the hydroformylation reaction is also referred to as synthesis gas. Carbonylation reactions of alkenes and alkynes in the presence of carbon monoxide, for example in the sense of a Reppe carbonylation, may also be carried out in the microcapillary reactor.

Thus, aspects of the invention are based on the surprising finding that gaseous products may be introduced in a controlled manner into liquid/liquid systems which are already intermixed. In this regard it is particularly advantageous that, by targeted selection of the capillary material, the gaseous starting components may be introduced in a targeted manner into the first or the second liquid phase. For example, in this manner the catalytic chemoselective hydrogenation of α,β-unsaturated aldehydes using hydrogen may be carried out with very high chemoselectivities and surprisingly good yields. Even for reaction times of only two to three minutes, which may be achieved using first transport lines having lengths of 3 to 12 m, for example, the yield is still above 10%. By combining multiple microcapillary reactors into reactor clusters or multi-microcapillary reactors it is also possible, particularly during continuous operation, to obtain product quantities which allow commercial manufacture of high-grade specialty chemicals, for example. This has the advantageous effect that process engineering safety measures may be reduced to a minimum, and also that complex cooling systems may be omitted in the case of exothermic reactions.

By use of the microcapillary reactor, it is also possible to obtain a defined flow behavior of a three-phase mixture (liquid/liquid/gaseous) in a controlled and reproducible manner.

Furthermore, the length of the individual plugs and the specific exchange surface between the phases may be set with great accuracy. Average plug lengths lie in the range of 0.1 to 3 mm. Since flow rates as well as droplet or plug sizes, which among other parameters are specified by the capillary diameter, may be precisely controlled, a microcapillary reactor as described herein may provide a superior instrument for accurately investigating and modeling the influence of mass transport on the reaction rate and selectivity.

In another aspect, the invention relates to use of microcapillary reactors as described herein. For example, the microcapillary reactors can be used for hydrogenation, hydroformylation, carbonylation, and oxidation of organic compounds.

The microcapillary reactors may be used not only for analytical purposes or product screening, but also suitably used for the commercial manufacture of chemical products, in particular high-grade specialty chemicals. In this regard the first transport line may flow into at least one product receiving container. Of course, to increase the quantity of product, multiple microcapillary reactors may also be operated in parallel. If, for example, the first mixer for a microcapillary reactor is present in a uniform material block, a multi-microcapillary reactor network may be obtained by incorporating not just one first mixer, but instead two or more such first mixers simultaneously into this uniform material block. Similarly, a plurality of adjacent second static mixers may be incorporated therein or in a further uniform material block by drilling, for example. A separate fourth extension line and/or a separate section of the first transport line is connected to the outlet of each second mixer. In a multi-microcapillary reactor network, all of the individual reactors may be operated under the same conditions, for example with regard to pressure, temperature, or flow rate. Alternatively, individual conditions may be set for each reactor. This latter embodiment of the multi-microcapillary reactor allows, for example, very efficient and rapid screening of, for example, various reaction conditions and/or catalysts for a given chemical reaction. The multi-microcapillary reactor described herein is therefore suited for use in combinatorial chemistry.

The use of the microcapillary reactor is discussed in detail below, using the chemoselective hydrogenation of the α,β-unsaturated aldehydes citral and prenal as an example.

For this purpose, a microcapillary reactor system essentially as illustrated in FIG. 4 was used. T-pieces from Valco were used as first and second mixers. The first transport line 10 was a polytetrafluoroethylene (PTFE) capillary having an inner diameter of 750 μm. The organic phase was supplied through a first supply line having the same inner diameter, using a Gynkotek M480 HPLC pump at a flow rate of 250 μL/min, whereas the aqueous phase was metered through the second supply line for the first mixer by use of a reciprocating pump with a delivery capacity of <600 μL/min. The two liquid phases present in mixed form in the first transport line after leaving the first mixer were contacted with hydrogen in the second mixer in the form of a T-piece from Valco. The continuous hydrogen stream was controlled using a conventional mass flow controller (MFC) which set the hydrogen partial pressure to 2.0 MPa. The section of the first transport line adjoining the second mixer was adjusted to a constant temperature of 60° by use of a water heater. Toluene or n-hexane was used as organic solvent. A Ru(II)-triphenylphosphine trisulfonate (TPPTS) complex was used as a hydrogenation catalyst. The hydrogenation catalyst was prepared from RuCl₃ and TPPTS in the presence of hydrogen (P_{H}2=2.0 MPa) at a temperature of 50° C. and a reaction time of one hour (C_{RU}=0.005, C_{TP}PTS=0.05 M). A pH of 7.0 was ensured during preparation of the hydrogenation catalyst by use of a buffer. Prenal (3-methylcrotonaldehyde) was used as a 0.5 M solution in n-hexane, and citral was used as a 0.25 M solution in toluene. Before being used in the microcapillary reactor, these solutions were degassed for approximately 15 minutes in an ultrasonic bath to minimize dissolved oxygen in the mixture.

Increasing the volumetric flow rate of the catalyst phase from 0.19 mL/min to 0.51 mL/min resulted in a 60% increase in the reaction rate (from 0.15 to 0.24×10⁻² mol/L⁻¹ min⁻¹). An even more pronounced effect was observed when the inner diameter of the capillary was reduced from 1000 to 500 μm (increase in reaction rate from 0.10 to 0.25×10⁻² mol/L⁻¹ min⁻¹). An increase in the flow rate consistently resulted in an increase in the Reynolds number, and thus also an increase in the mass transfer ratio. It is assumed that the mass transport at the liquid/liquid phase boundary controls the reaction kinetics. As a result of the higher affinity of the organic phase for a surface material having low surface energy, for example Teflon, a frictional force on the edge regions of the organic plug opposing the direction of flow is expected. As a consequence of these shear forces, which become more noticeable with increasingly smaller inner diameters of the capillaries, an internal circulation results within the plug. Since increased reaction rates result from decreasing the capillary inner diameter, it is presumed that the internal circulation influences or accelerates the mass transport.

The features of the invention disclosed in the above description, the drawings, and the claims may be important, individually or in any given combination, for implementing the invention in its various embodiments.

### LIST OF REFERENCE NUMERALS

1 Microcapillary reactor
2 First mixer
4 Second mixer
6 First supply line
8 Second supply line
10 Transport line
12 Third supply line
14 First extension line
16 Second extension line
18 Third extension line
20 Fourth extension line
22 HPLC pump
24 Aqueous phase supply container
26 Sample analyzer
28 Product collection container
30 a, b, c Connector
32 a, b, c Connector
34 Aqueous fluid block
36 Organic fluid block
38 Gaseous phase
40 Heater
42 Starting product supply container
44 Hydrogen supply container
46 Ar supply container
48 Mixing station
50 Reciprocating pump
52 Branch line
100 Microcapillary reactor system

The embodiments of the invention in which an exclusive property or privilege is claimed are defined as follows:

1. A microcapillary reactor, comprising:
(a) at least one first static mixer for producing alternating, nonhomogeneously miscible fluid blocks while maintaining or forming a cohesive fluid stream in the form of plug flow system, comprising
(i) at least one first capillary supply line for a first liquid fluid; and
(ii) at least one second capillary supply line for a second liquid fluid,
wherein the second liquid fluid is not substantially homogeneously miscible with the first fluid,
wherein the first and second capillary supply lines flow through opening sections into a region which is the starting point for at least one first transport line, and wherein at least the first and second capillary supply lines are dimensioned such that the first and second fluids are each transported under laminar flow conditions and are transmitted in the first transport line in the form of successively alternating, discrete liquid phase plugs; and
(b) at least one second static mixer for the selective feeding of a gaseous third fluid into the plugs of only the first or the second fluid, containing at least one third supply line having an opening for a gaseous third fluid which flows into the first transport line downstream from the first mixer,
wherein at least the inner wall of the first transport line is provided with a polarity that has a greater affinity for the first or the second fluid.

2. The microcapillary reactor of claim 1, wherein the inner wall of the first, second, and/or third supply line is provided with a polarity that has a greater affinity for the first or second fluid.

3. The microcapillary reactor of claim 1, wherein the third supply line is a capillary supply line.

4. The microcapillary reactor of claim 1, further comprising extension lines for the first, second, and/or third supply line, and/or the first transport line, wherein the extension lines have a polarity that has a greater affinity for the first or second fluid.

5. The microcapillary reactor of claim 4, wherein at least part of the inner wall of the first transport line in the adjoining section downstream from the second mixer is provided in a nonpolar state.

6. The microcapillary reactor of claim 4, wherein at least part of the inner wall of the first transport line is composed of a nonpolar plastic.

7. The microcapillary reactor of claim 6, wherein the nonpolar plastic is composed of polytetrafluoroethylene.

8. The microcapillary reactor of claim 4, wherein at least part of the inner wall of the first transport line is composed of metal and/or glass.

9. The microcapillary reactor of claim 1, wherein the first transport line may be thermostatically controlled upstream and/or downstream from the opening of the third supply line.

10. The microcapillary reactor of claim 1, wherein at least part of the first supply line, the second supply line, the third supply line, and/or the first transport line has a diameter not exceeding about 1000 μm.

11. The microcapillary reactor of claim 4, wherein at least part of at least one extension line has a diameter not exceeding about 1000 μm.

12. The microcapillary reactor of claim 1, wherein the length of the section of the first transport line that starts downstream from the opening of the third supply line into the second mixer ranges from about 0.1 to about 50 m.

13. The microcapillary reactor of claim 1, wherein the first and second supply lines for the first mixer have opening sections that are essentially oppositely oriented.

14. The microcapillary reactor of claim 1, wherein the first and second supply lines meet with their opening sections oriented at essentially right angles, at an angle between 90° and 180°, or at an angle between 0° and 90°.

15. The microcapillary reactor of claim 1, wherein the third supply line for the second mixer and the section of the first transport line extending downstream from the opening section of the second supply line meet oppositely at an angle of about 180°.

16. The microcapillary reactor of claim 1, wherein, at its opening, the third supply line for the second mixer flows into a section of the first transport line supplying the first and second fluids perpendicularly, at angle between 0° and 90°, or at an angle between 90° and 180°.

17. The microcapillary reactor of claim 1, wherein the first and/or second mixer is a T- or Y-mixer.

18. The microcapillary reactor of claim 1 further comprising a product receiving container, wherein the product receiving container opens into the first transport line.

19. A multi-microcapillary reactor comprising at least two microcapillary reactors of claim 1.

20. A method for controlled mixing of at least two liquid fluids which are not substantially homogeneously miscible and at least one gaseous fluid, using a microcapillary reactor, comprising:
combining a first liquid fluid via at least one first capillary supply line for a first static mixer and a second liquid fluid via at least one second capillary supply line for the first static mixer in a region which is the starting point for at least one first transport line,
wherein the first and second capillary supply lines and the transport line are dimensioned such that the first and second fluids are each transported under laminar flow conditions and transmitted in the first transport line in the form of successively alternating, discrete liquid phase plugs; and
feeding a gaseous third fluid into the first transport line downstream from the first mixer via at least one third supply line having an opening for a second static mixer,
wherein at least the inner wall of the first transport line has a polarity which has a greater affinity for the first or the second fluid.

21. The method of claim 20, wherein the inner wall of the first, second, and/or third supply line have a polarity which has a greater affinity for the first or the second fluid.

22. The method of claim 20, wherein the microcapillary reactor is a microcapillary reactor of claim 1.

23. The method of claim 20, wherein the microcapillary reactor is a multi-microcapillary reactor of claim 19.

24. The method of claim 20, wherein the third supply line is a capillary supply line.

25. The method of claim 20, wherein at least part of the inner wall of the first transport line and/or the first, second, and/or third supply line has a polarity that has a greater affinity for the first or second fluid.

26. The method of claim 20, wherein at least part of the inner wall of the first transport line is composed of a plastic in the adjoining section downstream from the second mixer.

27. The method of claim 26, wherein the plastic is composed of polytetrafluoroethylene in the adjoining section downstream from the second mixer.

28. The method of claim 20, wherein the first fluid comprises an organic phase and a second phase comprising an aqueous phase.

29. The method of claim 20, wherein at least part of the first, second, and/or third supply line, the first transport line, and/or at least one extension line has a diameter not exceeding 1000 μm.

30. The method of claim 20, wherein the length of the section of the first transport line, which starts downstream from the opening of the third supply line into the second mixer, ranges from about 0.1 m to about 50 m.

31. The method of claim 20, wherein the first and second supply lines for the first mixer have opening sections that are essentially oppositely oriented.

32. The method of claim 20, wherein the first and second supply lines meet with opening sections oriented at essentially right angles, at an angle between 90° and 180°, or at an angle between 0° and 90°.

33. The method of claim 20, wherein, at its opening, the third supply line for the second mixer flows into the section of the first transport line supplying the first and second fluids perpendicularly, at angle between 0° and 90°, or at an angle between 90° and 180°.

34. The method of claim 20, wherein the first and/or second mixer is a T- or Y-mixer.

35. The method of claim 20, wherein the gaseous third fluid is hydrogen, oxygen, carbon monoxide, or a hydrogen/carbon monoxide mixture.

36. The method of claim 20, wherein the flow rates of the first and second fluid in the first or second supply line or the multiphase mixture in the first transport line range from about 6 to about 15,000 μL/min.

37. The method of claim 20, wherein the plugs of an aqueous and/or organic phase have a length ranging from about 0.1 to about 3 mm.

38. The method of claim 20, wherein the first fluid is an organic phase comprising at least one organic starting material dissolved therein that can be reduced by hydrogen, the second fluid is an aqueous phase comprising a homogeneously dissolved hydrogenation catalyst, and the gaseous third fluid is hydrogen.

39. The method of claim 37, wherein the organic starting material is an α,β-unsaturated aldehyde.

40. The method of claim 20, wherein the first fluid is an organic phase comprising at least one olefin dissolved therein, the second fluid is an aqueous phase comprising a homogeneously dissolved hydroformylation catalyst, and the gaseous third fluid is a hydrogen/carbon monoxide mixture.

41. The method of claim 20, wherein the first fluid is an organic phase comprising at least one organic starting material dissolved therein that can be oxidized by oxygen, the second fluid is an aqueous phase comprising a homogeneously dissolved oxidation catalyst, and the gaseous third fluid is oxygen.

42. The method of claim 20, wherein the first fluid is an organic phase comprising at least one organic starting material dissolved therein which can be carbonylated by carbon monoxide, the second fluid is an aqueous phase comprising a homogeneously dissolved carbonylation catalyst, and the gaseous third fluid is carbon monoxide.

43. A method of performing a chemical reaction in a liquid/liquid/gaseous multiphase system, wherein the chemical reaction is carried out by a microcapillary reactor of claim 1.

44. The method of claim 42, wherein the chemical reaction is selected from a group consisting of catalytic hydrogenation, hydroformylation, oxidation, and carbonylation.

45. The method of claim 42, wherein the chemical reaction is carried out by a multi-microcapillary reactor of claim 19.

46. The method of claim 44, wherein the chemical reaction is selected from a group consisting of catalytic hydrogenation, hydroformylation, oxidation, and carbonylation.
